(19) United States
(12) Patent Application Publication
(10) Pub. No.: US 2024/0082093 A1
(43) Pub. Date: Mar. 14, 2024

(54) EXPANDED FUNCTIONALITY URN

(71) Applicant: Be Legendary LLC, Virginia Beach, VA (US)

(72) Inventor: Thomas PARKER, Virginia Beach, VA (US)

(21) Appl. No.: 18/263,510

(22) PCT Filed: Jan. 28, 2022
(86) PCT No.: PCT/US2022/014319

§ 371 Date: Jul. 28, 2023

Related U.S. Application Data
(60) Provisional application No. 63/142,760, filed on Jan. 28, 2021.
(60) Provisional application No. 63/180,287, filed on Apr. 27, 2021.

(51) Int. Cl. A61G 17/08; G06F 21/62; G06K 19/07; H04B 5/00

(52) U.S. Cl. CPC A61G 17/08; G06F 21/6218; G06K 19/0723; H04B 5/0031; G06F 2221/2141

(57) ABSTRACT

Disclosed herein are embodiments of an urn comprising an attachment communication module allowing nearby users to access digital memories associated with the communication module.

### RELATED APPLICATIONS

This application claims the benefit of U.S. Provisional Patent Application No. 63/142,760, filed Jan. 28, 2021 and U.S. Provisional Patent Application No. 63/180,287, filed Apr. 27, 2021, the entire disclosures of which are herein incorporated by reference.

### INCORPORATION BY REFERENCE

All publications and patent applications mentioned in this specification are herein incorporated by reference in their entirety to the same extent as if each individual publication or patent application was specifically and individually indicated to be incorporated by reference.

### FIELD

This application relates to the field of funerary urns.

### BACKGROUND

Funerary urns (also called cinerary urns and burial urns) have been used by many civilizations. After death, corpses are cremated, and the ashes are collected and put in an urn.

### SUMMARY

In a first aspect of the invention, an urn is provided. The urn comprises a receptacle comprising a cavity and comprising a first opening near a top of the receptacle and leading to the cavity, the receptacle comprising an inner wall and an outer wall defining a storage area between the inner and outer walls; a second opening providing access to the storage area; a cap configured to close the second opening; and a wireless communication module accessible by users and configured to provide users access to stored or associated data.

In some embodiments, the urn comprises a removable cover configured to cover the first opening. The urn can comprise a removable insert configured to be inserted into the first opening and to receive material. In some embodiments, the urn comprises a ring cap configured to be positioned around a rim of the first opening and around a top edge of the removable insert. The second opening can be positioned at a bottom portion of the urn. In some embodiments, the cap comprises a plug. The second opening can comprise threads. In some embodiments, the wireless communications module comprises an attachment mechanism for attaching to the urn. The attachment mechanism can be adhesive or a clip. In some embodiments, the wireless communication module is configured to be positioned around the first opening.

In another aspect, a communications device is provided. The device comprises a wireless communications module accessible by users and configured to provide users access to stored or associated data; and an attachment mechanism configured to allow attachment of the wireless communications module to an urn.

In some embodiments, the device is configured to be recognizable by nearby communications devices. In some embodiments, nearby communication devices comprise smartphones, computers, laptop computers, tablets, or smartphones. The device can be configured to send an alert to nearby devices. In some embodiments, the device is configured to offer access to nearby devices.

The device can comprise a passive communications transmitter. In some embodiments, the passive communications transmitter comprises a RFID or an NFC tag.

The device can allow for privacy setting modification, thereby only allowing selected nearby devices access to the stored or associated data. In some embodiments, the stored or associated data is accessible using a user interface on a device based application. The stored or associated data can be accessible using an internet browser. In some embodiments, the device comprises an on-board memory, and wherein the stored or associated data is stored in the on-board memory. The stored or associated data can comprise at least one or more of an epitaph, obituary, voice recording, video, picture, and textural format.

In some embodiments, the device or an application associated with the device is configured to automatically create a standard digital memorial for display through a user interface comprising a selection from the stored or associated data. The device or an application associated with the device can be configured to automatically gather content from social media and other supplied material using facial recognition and artificial intelligence to generate the standard digital memorial. In some embodiments, the device or an application associated with the device is configured to create a digital memorial with one of a variety of themes for display through a user interface.

The urn can comprise any object or container configured to hold cremains. In some embodiments, the device is configured to be attached to a door of an urn.

The device can be sized and/or configured to be stored within a storage portion of an urn. In some embodiments, the device or an application associated with the device is configured to be synced to a social media platform and pull content from a user profile.

The device or an application associated with the device can be configured to prompt alerts or communications. In some embodiments, the device or an application associated with the device is configured to access a social media user profile and pull contacts therefrom. The device can comprise a speaker. In some embodiments, the device is associated with a storage location for an urn. The device or an application associated with the device can be configured to create a unique identifier for users. In some embodiments, the unique identifier is configured to identify the level of access a user has. The unique identifier can be configured to identify a user as having permission to upload data to the device. In some embodiments, the uploaded data is stored in cloud based storage linked to the user's profile. An application associated with the device can be configured to allow uploading and storage of hard copy photos, voice recordings, and photos of other items through a user interface. In some embodiments, the device or an application with the device is configured to contact known contacts. The device or an application associated with the device can be configured to contact known contacts and prompt the contacts to download the software. In some embodiments, the application is configured to grant users access to one or more of a digital funeral, remote wake, online celebration of life ceremony, and digitally connected memorial service providers. The application can be configured to display accessible resources and events through a user interface.

### BRIEF DESCRIPTION OF THE DRAWING

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIGS. 1A and 1B show various views of embodiments of an urn.

FIGS. 2A-2C show various views of embodiments of an insert for an urn.

FIG. 3 shows another view of an embodiment of an urn.

FIGS. 4A-4C show various views of embodiments of a plug for sealing a compartment of an urn.

### DETAILED DESCRIPTION

Described herein are embodiments of a communications module that can be associated with a funerary object or place (e.g., urn, burial plot, mausoleum, memorial site, etc.). The communications module can allow a digital legacy to be left by and/or for the deceased and associated with their funerary site. For example, a communications module can allow a traditional urn to be associated with a digital footprint of the deceased. This functionality can allow a person or a person's family to control the content to create a lasting digital memorial. Digital access to this content can allow a much larger group of people to participate in a digital memorial than would otherwise attend an in-person memorial service. Described herein are also embodiments of an improved funerary urn.

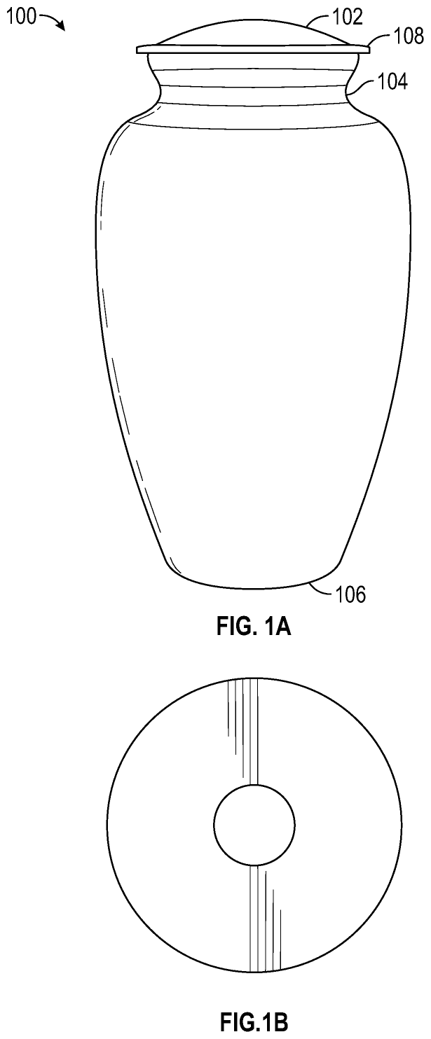

Referring to FIGS. 1A-1B, in some embodiments, the urn can both serve to contain a deceased's ashes as well as function as an open container (e.g., vase) for decorative display. FIGS. 1A and 1B show a front view and bottom view, respectively, of an embodiment of an urn 100. The urn comprises a body with an opening 110 a top end of the body. A removable cover 102 can be used to close the opening. In some embodiments, the urn does not comprise a cover.

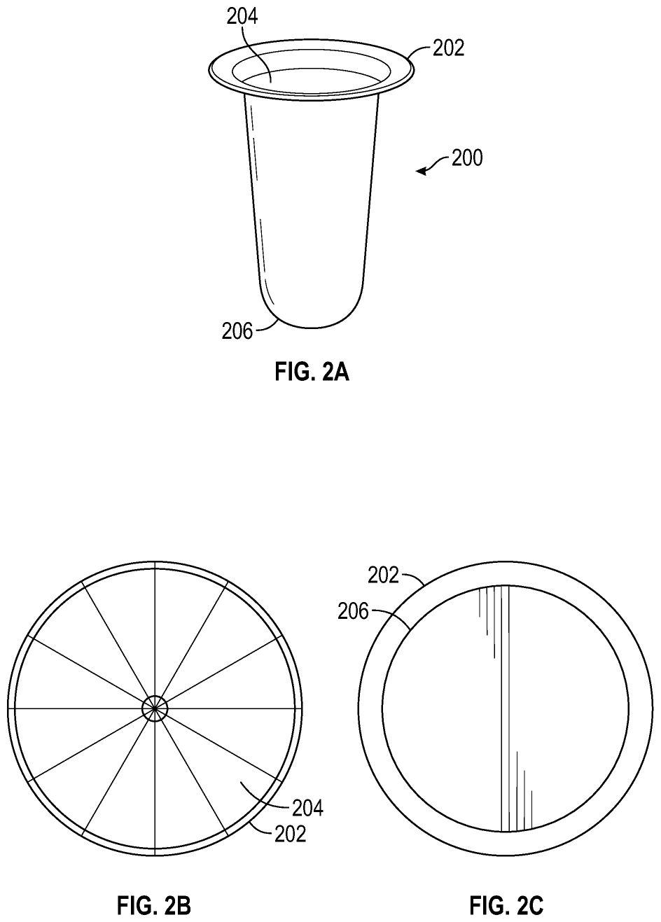

The urn 100 is shown as having a neck portion 104 near a top end of the body. The body of the urn widens from the neck portion 104 towards the top end of the body. A ring cap 108 can be removably positioned at the top of the urn 100. The ring cap 108 can resemble a flange as shown in FIG. 1A. The ring cap 108 can be used to hide a top portion of the vase insert. In some embodiments, the ring cap can also secure a top portion of a vase insert (FIGS. 2A-2C) to a top portion of a the urn. It will be appreciated that, in some embodiments, the urn does not include a neck portion.

In some embodiments, below the neck portion, the outer body extends radially outwardly away from a central axis of the urn as it moves away from the neck portion. From an outermost portion of the body, it extends radially inward towards the bottom 106 of the urn 100. It will be appreciated that, in some embodiments, the urn comprises a different shape (e.g., generally cylindrical, generally spherical, polyhedral, etc.).

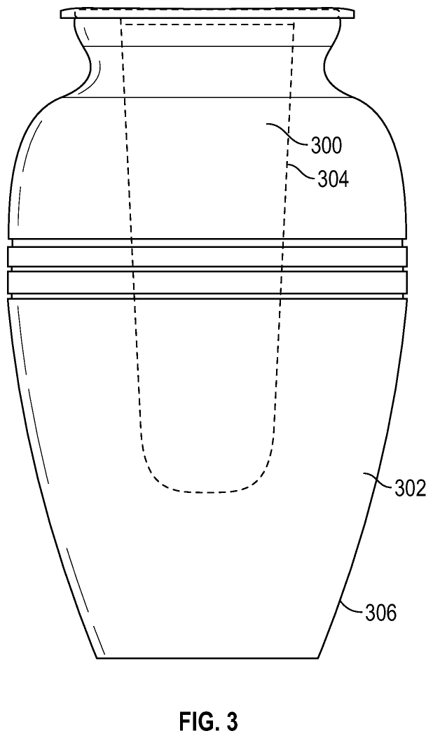

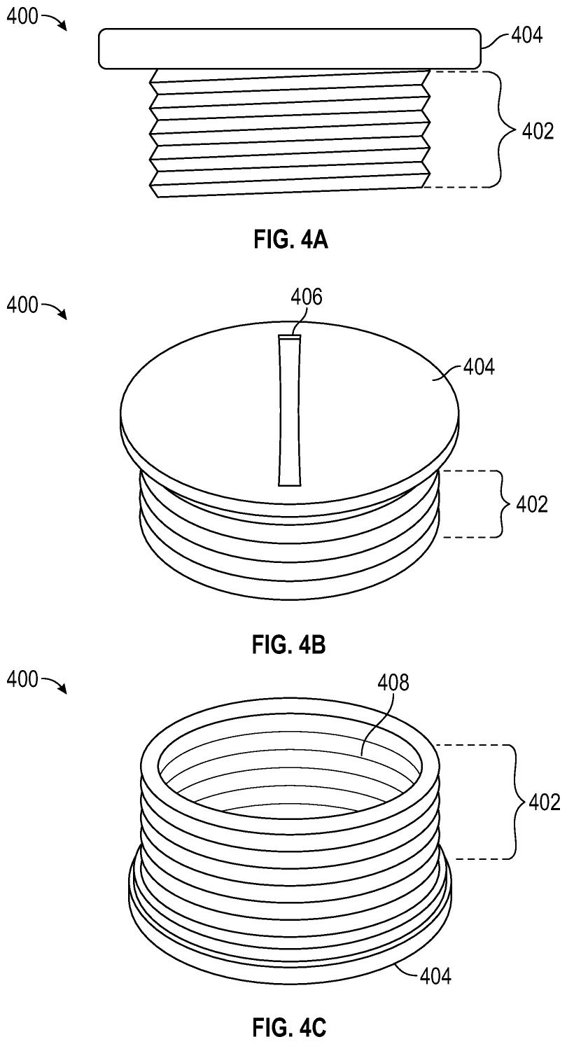

As shown in the bottom view of FIG. 1B, an opening 112 at the bottom of the urn can be used to access an outer cavity (FIG. 3) of the urn, for example, for storing ashes. The opening can be sealed by a cap or plug (e.g., as shown in FIGS. 4A-4C and described in more detail below).

The urn can comprise any metal, stone (artificial of real), synthetic material, those other materials which are commonplace and practical in urn manufacturing.

Moving to FIGS. 2A-2C, a front view, top view and bottom view, respectively, of an embodiment of an insert 200 for an urn (e.g., urn 100) is shown. The insert comprises a vessel configured to fit within the urn. The insert 200 comprises a lip 202 around a top opening 204 of the insert 200. The lip 202 can serve to rest on a corresponding flange around or near a top opening of an urn. Below the lip portion, the insert comprises a generally cylindrical shape. The circumference of the insert may decrease towards a bottom portion 206 of the insert (e.g., creating a taper). In some embodiments, a circumference or width or diameter of the insert stays constant along a length of the insert. It will be appreciated that the insert can comprise any shape as long as it provides a vessel that can be inserted into and removed from the urn. The insert can comprise plastic, vinyl, glass, metal, or any other impervious material capable of containing water in a leakproof manner.

A removable insert allows a user to add, maintain, or replace decorative material, such as flowers, to the urn without excessively disturbing the urn or the contained ashes. In some embodiments, the urn does not comprise such an insert. In these embodiments, decorative material can be placed directly into the top opening of the urn.

FIG. 3 shows a front view of the urn 100 and the internal insert cavity 300 (shown in broken line). The internal insert cavity is defined by an inner wall 302 of the urn 100. An outer cavity 302 is formed by the inner wall 304 and outer wall 306 of the urn. This outer cavity is configured to receive the ashes of the deceased.

In some embodiments, the cavity 302 comprises a volume of about 200 in³, the volumes of the ashes of an average sized man. Other volumes are also possible (e.g., about 150-200 in³, about 175-225 in³, about 190-210 in³, etc.). Other configurations for ash storage are also possible (e.g., a compartment positioned at a bottom portion of the urn). Additionally, in some embodiments, the outer cavity may be accessed at a different location than at the bottom of the urn (e.g., via an opening on a side or top portion of the urn).

In some embodiments, the lip 302 of the insert 300 can be joined to the opening of the urn 100 using ring cap 108. Other means for allowing the insert to rest on or join with a top portion of the urn are also possible. For example, the urn 100 can comprise hooks configured to hold a corresponding feature (e.g., hook, lip, flange) of the urn. For another example, the lip 302 of the insert 300 can rest on a corresponding flange of the urn. In some embodiments, the urn can comprise a groove configured to receive a lip of the insert. In some embodiments, a bottom portion of the insert can be positioned to rest on a bottom surface of the cavity of the urn.

Moving to FIGS. 4A-4C, a front view, top perspective view, and a top perspective inverted view, respectively, of an embodiment a plug for sealing the opening at the bottom of the urn are shown. The plug 400 can comprise threads along a threaded portion 402 of the plug. The plug 400 can comprise a cap 404 at a top portion of the plug. The cap can comprise a feature 406 (e.g., a handle, a depression configured to mate with a tool) to aid in turning the cap. The cap can comprise a larger diameter than the threaded portion of the plug to help ensure a better seal of the outer cavity. Other configurations of the plug are contemplated. For example, a friction-fit plug can be used. An interior 408 of the cap can be hollow as shown in FIG. 4C. In other embodiments, it can be solid.

In some embodiments, the urn comprises a communications module. The communications module can enable wireless communication (e.g., via wifi, Bluetooth, RFID, near field communication, etc.). The communications module can comprise an outer housing. The housing can be waterproof and configured to protect the contents from the elements. The communications module can comprise an attachment mechanism for attaching to the urn. For example, the communications module may comprise a clip. In some embodiments, the communications module may be configured to be positioned within the ring cap. In some embodiments, the communication module is shaped to rest within a portion of the urn (e.g., around the top opening of the urn. The attachment mechanism can be configured to wrap around the urn (e.g., around a neck portion of the urn).

In some embodiments, the communications module comprises a passive communications transmitter (e.g., RFID tag, NFC tag, etc.). A passive transmitter can advantageously allow the interacting device instead of the transmitter to supply the power for the communication.

The communications module can be configured to be accessible or allow access to nearby users. In some embodiments, the module can be configured to recognize devices (e.g., computers, laptops, smartphones, tablets, etc.) belonging to nearby users. In an alert setting, the module or a related device based app can be configured to send an alert (e.g., text message, push notification, etc.) to nearby devices. These alerts can notify a user that a memorial site is in range and ask whether the user would like to access the associated data (e.g., view digital memorial). In some embodiments, the devices can be configured to enable or disable receiving of such alerts. In some embodiments, the user must have the app downloaded to receive notifications and/or alerts. A user can use a user interface on the application to locate nearby devices.

In some embodiments, the module or a related device based app can be capable of privacy setting modification. In such embodiments, the module or a related device-based app can be configured to allow access to nearby devices that are recognized devices or devices belonging to members of an accepted user group. These settings can be set by the deceased antemortem or by the party with rights to the content postmortem.

As described above, in some embodiments, a device based app user interface can be used to select a nearby urn communications module. In some embodiments, the urn communications module can also be accessed using an internet browser.

Data associated with the urn communications module can be uploaded and accessed via a user interface (e.g., on an app, through an internet browser). In some embodiments, the data can be stored in a cloud database. In some embodiments, the data can be stored in an on-board memory. A combination of remote and on-board storage can also be used to store data. In some embodiments in which the data is stored in a remote site, the wireless communications module can be configured to access the remote site and transmit the data to the user (e.g., nearby user).

Data associated with the urn communications module can include, but is not limited to, an epitaph, an obituary, voice recordings, videos, pictures, textural formats, etc. The data can be supplied pre-mortem by the deceased (and/or others) or post-mortem by others, including friends and family. In some embodiments, the user interface can comprise user settings that authorize certain users to upload, download, and/or access data.

In some embodiments, the user interface (e.g., device based app, online platform) can be configured to create a standard digital memoriam. The user interface can be configured to automatically pull from social media content and any other supplied material using facial recognition, and light artificial intelligence to generate a standard digital memorial. The digital memorial can comprise a collection of any or all of the following: photos, videos, sound recordings, quotes, religious texts, etc. In some embodiments, the app or platform can be configured to use stock or online data to fill in gaps when creating the digital memorial.

In some embodiments, the app or online platform can comprise functionality to generate digital memorials with various themes (e.g., sentimental, humorous, religious, etc.).

In some embodiments, the application user interface can be configured to sync with the existing social media platforms. For example, the user interface can be configured to communicate with and pull content from the deceased's or a user's social media profile.

In some embodiments, the data associated with the module can be accessed remotely, over an internet connection. This sort of remote access can allow for digital remembrance of the deceased by a larger group of people than those that are in the immediate area or are available to travel to the immediate area.

In some embodiments, the user interface can be configured to set up alerts and communications. For example, in some embodiments, a person can prepare an antemortem list of people to be notified upon their death and to be invited to participate in a digital memoriam. In some embodiments, the user interface can be configured to access a person's social media profile and pull from the contact list (e.g., all contacts, subset of contacts, etc.).

In some embodiments, the communications module can be integrated into an urn design, e.g., the urn described with respect to FIGS. 1A-4C. In some embodiments, the communication module can be configured to be attached to a separate, existing urn. In some embodiments, the communication module can be configured to be associated with other location of remembrance, such as at a burial plot or at a mausoleum.

It will be appreciated that a separate, existing urn can comprise any object or container configured to hold cremains. For example, a communications module can be attached to jewelry such as a bracelet or necklace, configured to hold cremains. Objects configured to hold cremains generally comprise a compartment for the cremains. In some embodiments, the communications module can be placed inside the compartment with the cremains or attached to the compartment door. The communications module (e.g., RFID tag or NFC tag) can be encapsulated (e.g., with silicone) and placed into or attached onto the object.

In some embodiments, adhesive can be used to attach the communications module (e.g., RFID tag or NFC tag) to the desired object.

In some embodiments, the communications module can be attached to a standard object (e.g., not configured to hold cremains).

In some embodiments, the communications module can come with a system configured to attach the communications module to the desired object. For example, a device (e.g., syringe) can be loaded with the communications module can be configured to insert the module within a small compartment of a cremains-holding object (e.g., a bracelet compartment, a locket or pendant, etc.). In some embodiments, a device can be loaded with the communications module and be configured to adhere the module to a portion of the desired object.

In some embodiments, the communications module itself can comprise a speaker configured to broadcast audio recordings. In some embodiments, the communications module comprises a visual display (e.g., display screen, holographic capability, etc.) configured to broadcast or display video.

The communication module can be associated with a storage location for the urn. For example, communications enabled urns can be stored in compartments or shelving or allotted positions in a storage facility where each urn storage location has a power and/or communications portal. This portal call allows the urn to be powered or have active communications capability such as internet access.

In some embodiments, the application user interface can be configured to allow a user to access other funerary services. For example, in some embodiments, flower delivery service can be set up via the user interface. This can be done antemortem or postmortem.

In some embodiments, the application automatically links to genealogy and ancestry data and provides and integrates this information to assist in protecting and connecting this data to the living and future descendants of the member.

In some embodiments, the application user interface allows the member and other trusted users the ability to upload additional digital data through the application interface. In some embodiments, the trusted users can use the application to upload voice recordings. In some embodiments, this data may be submitted to allow artificial intelligence and advanced programming to recreate the voice of the deceased, to speak selected phrases, say a prayer or blessing, storytelling, spoken memories, etc.

In some embodiments, the application interface can also be used to upload and digitize hard copy photos, memorabilia, locations of importance, new voice recordings, items of importance, other sentimental data, etc.

In some embodiments, the application user interface can be configured to prompt permission for other stock data to be automatically gathered from online and incorporated into the digital memorial database and digital memories. Examples include but are not limited to music, inspirational quotes, religious quotes, stock photos/videos, memes, or other value added data that will help create unique and meaningful digital memories for each member. These parameters can be customized and users can allow or disallow any available feature.

In some embodiments, the application can be configured to utilize the uploaded or gathered data and perform digital scrapbooking functionality.

In some embodiments, the application can be configured to invite all or a selection of contacts to participate in digital memorial of the member once the member is deceased and allow participants to download the application and become users of the application. Users are then granted permission to participate in digital funeral, remote wake, online celebration of life ceremony, and/or other digitally connected memorial service providers. Digitally connected memorial service providers can include, but are not limited to flower delivery, grief services, counseling, e-cards, sympathy gifts, memorial merchandise, cremation jewelry, condolence items, life insurance services, estate planning/will services, etc.

Once users are granted permission, they can view the digital memories of the member at any time through the application interface. When placed in close proximity (e.g., 1-3 cm) to the communications module, the application will activate and provide a digital memory of the member on the application user's interface.

In some embodiments, where a user has not already downloaded the application, close proximity can cause the device to prompt download of the application.

### Example 1—Application Functionality and Workflow as Follows

Permission Granted and Unique Identification Created for a communications module primary user (member). The primary user can refer to the member post or ante mortem. The member is assigned a unique identifier linked to the communications module.

The member is granted permission to access the data associated with the communications module and add and modify digital content that will be stored in the communications module or associated storage location. This database will store the data for viewing in perpetuity and to generate randomized or pre-programmed digital memories, including but not limited to snapshots of the life of, or milestones and achievements of, important moments of, lessons learned by the member.

Other users may also be granted access to upload and/or access stored data.

The communications module application automatically gathers existing social media data and footprint of the member, including but not limited to images, voice recordings, videos, contacts, genealogy, ancestry lineage, family tree, etc. The application stores this data in a cloud based data storage linked to the member's memorial database. Optionally, online software uses facial recognition software to search photos and videos of data on the internet belonging to the member's contacts. Any data found containing pictures of the member then are permitted to be part of the digital Memorial Database.

All of the functions above can use one or more of the Internet of Things connectivity, cloud storage, software, algorithms, Artificial intelligence, programming, and engineering as required.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1-10. (canceled)

11. A communications device comprising
a wireless communications module accessible by users and configured to provide users access to stored or associated data; and
an adhesive attachment mechanism configured to allow attachment of the wireless communications module to an urn.

12. The communications device of claim 11, wherein the device is configured to be recognizable by nearby communications devices.

13. The communications device of claim 12, wherein the nearby communication devices comprise smartphones, laptop computers, tablets, or smartphones.

14. (canceled)

15. The communications device of claim 11, wherein the device is configured to offer access to nearby devices.

16. The communications device of claim 11, wherein the device comprises a passive communications transmitter.

17. The device of claim 16, wherein the passive communications transmitter comprises a RFID or a NFC tag.

18. (canceled)

19. The communication device of claim 11, wherein the stored or associated data is accessible using a user interface on a device based application.

20. (canceled)

21. The communications device of claim 11, wherein the stored or associated data is stored in a cloud database.

22. The communications device of claim 11, further comprising an on-board memory, and wherein the stored or associated data is stored in the on-board memory.

23. The communications device of claim 11, wherein the stored or associated data comprises at least one or more of an epitaph, obituary, voice recording, video, picture, and textural format.

24. (canceled)

25. (canceled)

26. The communications device of claim 11, wherein the device or an application associated with the device is configured to create a digital memorial with one of a variety of themes for display through a user interface.

27.-34. (canceled)

35. The communications device of claim 11, wherein the device or an application associated with the device is configured to create a unique identifier for users.

36. The communications device of claim 35, wherein the unique identifier is configured to identify the level of access a user has.

37. The communications device of claim 35, wherein the unique identifier is configured to identify a user as having permission to upload data to the device.

38. (canceled)

39. The communications device of claim 11, wherein an application associated with the device is configured to allow uploading and storage of hard copy photos, voice recordings, and photos of other items through a user interface.

40. (canceled)

41. (canceled)

42. The communications device of claim 11, wherein an application associated with the device the application is configured to grant users access to one or more of a digital funeral, remote wake, online celebration of life ceremony, and digitally connected memorial service providers.

43. The communications device of claim 42, wherein the application is configured to display accessible resources and events through a user interface.

44. The communications device of claim 11, wherein the attachment mechanism comprises a clip.
